(19) United States
(12) Patent Application Publication
(10) Pub. No.: US 2002/0057842 A1
(43) Pub. Date: May 16, 2002

(54) Smart handwriting recognition apparatus and methods

(76) Inventor: Henry C. Yuen, Pasadena, CA (US)

Correspondence Address: John G. Posa, Gifford, Krass, Groh et al, Suite 400, 280 N. Old Woodward Ave., Birmingham, MI, 48009, US

(21) Appl. No.: 09/872,993

(22) Filed: Jun. 1, 2001

Related U.S. Application Data
(60) Provisional application No. 60/209,117, filed on Jun. 2, 2000.

(51) Int. Cl. G06K 9/72

(52) U.S. Cl. 382/229

(57) ABSTRACT

A method of handwriting recognition encourages the entry of an entire word, and presents the “most likely” word or words. A “look-ahead” mode of operation is implemented, wherein most probable word or words corresponding to the entered letters are identified in a dictionary; and presented to the user in such a way that the user may discontinue the entry of further letters if one the words identified in the dictionary matches the desired word. The determination of the most likely word or words may be based on a combination of one or more criteria, including the characters themselves, the length of the word, the relative placement of the recognized characters within the word, and so forth. The result may also be presented in various ways singly or in combination according to the invention. In addition to a presentation of the highest probable word, the ‘n’ highest probable words may be presented. Alternatively, the highest probable word may be presented and, upon prompting by the user, presentation of a number of next highest probable words.

### REFERENCE TO RELATED APPLICATION

This application claims priority from U.S. provisional patent application Ser. No. 60/209,117, filed Jun. 2, 2000, the entire contents of which are incorporated herein by reference.

### FIELD OF THE INVENTION

This invention relates generally to handwriting recognition and, in particular, to the use of “look ahead” techniques to improve such systems.

### BACKGROUND OF THE INVENTION

Entering handwritten text information is becoming increasingly important for many computer devices, especially portable devices which seek to avoid the extra weight and size of keyboards. Various handwriting recognition schemes have been developed for pen-based and “palm-top” devices, for example, “Graffiti” used by Palm, Allegrio used by Rocket eBook, and T-9 is available as an option to a number of devices.

Error-free recognition is difficult for many reasons. For one, characters such as the letter “O” and the number zero are very similar. Thus, in addition to shape matching, the accuracy of handwritten character recognition is improved when the character is also analyzed with respect to its context.

As discussed in U.S. Pat. No. 6,111,985, the contents of which are incorporated herein by reference, context-based recognition may be done in a backward-context approach or a full-context approach. Backward-context recognition analyzes previous characters, if any, to determine the best translation of the current character. A full-context approach looks at the characters both before and after each character in a string to assist with recognition.

Backward-context recognition is less accurate than full context recognition because only a portion of the context is available until a string or word is completed. Thus, whereas full-context recognition provides a relatively high level of recognition accuracy, the user receives no feedback until the string is complete.

A compromise solution has been attempted in which backwards context recognition is initially performed to provide instantaneous feedback, while full-context recognition is later performed to increase recognition accuracy. However, this solution has the effect of changing characters that have already been displayed, an approach which can be unacceptably annoying to some users.

Existing “letter-by-letter” entry schemes also significantly slow down the input mechanism, as the user is forced to write out a word character by character, while paying close attention to the accuracy of each character as it is entered. The combination of these two effects renders the current handwriting recognition scheme (HRS) both inaccurate and inconvenient. The need remains, therefore for a handwriting recognition scheme to replace or augment letter-by-letter entry schemes, particularly for use in conjunction with mobile computing and telecommunications devices.

### SUMMARY OF THE INVENTION

This invention resides in a handwriting recognition scheme which encourages the entry of an entire word, and presents the “most likely” word or words. A “look-ahead” mode of operation is implemented, wherein most probable word or words corresponding to the entered letters are identified in a dictionary; and presented to the user in such a way that the user may discontinue the entry of further letters if one the words identified in the dictionary matches the desired word.

Due to the fact that there are only a finite number of words, while there is a much larger permutation of possible unrelated characters, the error rate for interpreting the word is significant reduced as compared with the cumulative error of interpreting each character. In addition, the user is permitted to enter an entire word at a time, far easier and more natural than character-by-character entry. As such, the invention improves the accuracy and ease of use of handwriting recognition schemes through the “look ahead” operation.

The determination of the most likely word or words may be based on a combination of one or more criteria, including the characters themselves, the length of the word, the relative placement of the recognized characters within the word, and so forth. The result may also be presented in various ways singly or in combination according to the invention. In addition to a presentation of the highest probable word, the ‘n’ highest probable words may be presented. Alternatively, the highest probable word may be presented and, upon prompting by the user, presentation of a number of next highest probable words.

### DETAILED DESCRIPTION OF THE INVENTION

This invention is directed toward improving the accuracy and ease of use of handwriting recognition schemes through the use of “look ahead” schemes. Broadly, the invention encourages the user to enter an entire word as in normal handwriting, using a dictionary to determine the mostly word entered. Due to the fact that there are only a finite number of words, while there is a much larger permutation of possible unrelated characters, the error rate for interpreting the word is significant reduced as compared with the cumulative error of interpreting each character. In addition, the user is permitted to enter an entire word at a time, far easier and more natural than character-by-character entry.

As an example, the handwritten entry of the word “invent” will be used. With traditional letter-by-letter recognition schemes, the probability of a first-time correct entry, assuming 90% accuracy for each character, is (0.90)**5=53%. On the other hand, using the same accuracy rating for letter-by-letter recognition, the ability for the system to narrow the alternatives down to one or two can be much higher. The additional information possessed by the computer may include the length of the word (an information which should be highly accurate); the relative locations of certain letters; and/or the elimination of impossible combinations.

The invention therefore resides in a handwriting recognition scheme which accepts an entire word, written in the user's handwriting, and presents the “most likely” word or words. The determination of the most likely word or words may be based on a combination of one or more criteria. In addition to the recognition of the characters themselves, the length of the word or the relative placement of the recognized characters within the word may be used. The relative placement of the characters together, with the estimated probability of recognition (which may be based on the specific input, or on cumulative experience of being able to recognize a particular letter or word), and/or the grammatical relationship of the word with previous word or words may also be used.

The result may be presented in various ways singly or in combination according to the invention. In addition to a presentation of the highest probable word, the ‘n’ highest probable words may be presented. Alternatively, the highest probable word may be presented and, upon prompting by the user, presentation of a number of next highest probable words.

The central processor may also be capable of interactively improving its recognition capability in one or more of the following ways. Fro example, the processor may use a different rule for different types of entry, such as “notes” vs. “address book.” In the former, proper nouns such as names will be given lower probability, and vice-versa for the latter. By comparing the presented word with the word selected by the user, reward-punishment rules may be applied to further improve recognition accuracy, both in the letter-by-letter mode and the word-by-word mode. Such rules may or may not be taken into account with respect to the “type” of the entry.

I claim:

1. A method of improving the accuracy and speed of a handwriting recognition system, comprising the steps of:
a) handwriting one or more letters of a desired word by a user;
b) implementing a “look-ahead” mode of operation, wherein most probable word or words corresponding to the entered letters are identified in a dictionary; and
c) presenting the most probable word or words to the user in such a way that the user may discontinue the entry of further letters if one the words identified in the dictionary matches the desired word.
